(19) United States
(12) Patent Application Publication
(10) Pub. No.: US 2025/0303950 A1
(43) Pub. Date: Oct. 2, 2025

(54) MOUNTABLE COOLER BRACKET AND METHODS FOR ADAPTING SAME

(71) Applicant: The Yak Bracket LLC, Jacksonville, FL (US)

(72) Inventors: Paul Veale, Jacksonville, FL (US); Eric Veale, Switzerland, FL (US)

(73) Assignee: The Yak Bracket LLC, Jacksonville, FL (US)

(21) Appl. No.: 19/097,581

(22) Filed: Apr. 1, 2025

Related U.S. Application Data
(60) Provisional application No. 63/572,719, filed on Apr. 1, 2024.

(51) Int. Cl. B60N 3/10; F16B 2/08; F25D 11/00

(52) U.S. Cl. CPC B60N 3/103; F16B 2/08; F25D 11/003; F16B 2200/83

(57) ABSTRACT

A cooler bracket attachment system for securely connecting a drink cooler to a golf cart. A cooler interlocks with (and may be strapped in to) a cooler receiver plate. The cooler receiving plate has a means of communicating with a corresponding plate on a golf cart, such as by corresponding magnets on both plates. The secure fastening of the cooler to the cooler receiver plate, and the secure connection of the cooler receiver plate to the corresponding plate on the golf cart, allows for modular, removable, and secure use of a cooler with a golf cart.

### CROSS REFERENCE TO RELATED APPLICATIONS

This application claims priority to U.S. Provisional Patent Application Ser. No. 63/572,719, entitled Mountable Cooler Bracket and Methods for Adapting Same, filed on Apr. 1, 2024. All content from that application is incorporated herein by reference.

### FIELD OF THE DISCLOSURE

The present disclosure relates generally to a bracket adaptable to a cooler to allow the cooler to be mounted on a movable surface, such as a golf cart.

### BACKGROUND OF THE DISCLOSURE

Golf is among America's most popular sports. Many golfers use small vehicles called golf carts to navigate golf courses. These golf carts often come equipped with storage, such as storage for the golf clubs used to play golf. Historically, golf has been as much a social event as a sporting competition, with players often spending several hours on the course. This duration, combined with the sport's typical outdoor setting, highlighted the need for readily available hydration and refreshment solutions, particularly in warmer climates.

Prior to the advent of built-in drink coolers, golfers relied on various makeshift methods to keep their beverages cold throughout their game. These included portable coolers carried by hand or attached in some fashion to the cart, often resulting in cumbersome setups that could interfere with the equipment's functionality or the game itself.

The evolution toward integrating drink coolers directly into golf carts can be seen as a response to these challenges, aiming to enhance the golfer's experience by providing a built-in, convenient, and efficient way to store drinks, keeping them cool and accessible throughout the round. This innovation not only improved practicality and convenience for players but also aligned with the broader trend of enhancing comfort and amenities in sports equipment.

Today, built-in drink coolers are a common feature in many high-end and even standard golf carts, reflecting a now-standard expectation among players for convenience and comfort on the course.

However, recent advances in cooler technology and design have necessitated larger coolers. These coolers may not fit neatly into any space appointed on a golf cart for holding the coolers. Additionally, some golfers prefer to bring their own drink coolers, which may be customized, more advanced, or better in some way than standard drink coolers.

Unfortunately, drink coolers can fall off or become otherwise separated from golf carts. Golf courses often vary greatly in terrain, such as in the grade and composition of the terrain. Given the potential weight of a cooler, most conventional cooler-storage solutions come with the risk that the cooler will fall off the golf cart while the golf cart is proceeding over this potentially rough and dynamic terrain.

### SUMMARY OF THE INVENTION

Accordingly, what is needed is a customizable, convenient, and safe assembly to attach a cooler to a frame of the golf cart.

According to the present disclosure, a bracket may be machined to fit one or more mounting points on a cooler. The bracket may include one or more connecting apparatus, such as a magnet. The bracket may interface with an attachment apparatus on the golf cart, such as a plate that has been fixably attached to the golf cart containing corresponding magnetic attachments or other magnetic fixations.

### BRIEF DESCRIPTION OF THE DRAWINGS

FIG. 1 depicts a top perspective view of a cooler bracket; specifically, a cooler receiver plate.

FIG. 2 depicts the cooler bracket as attached to a cooler.

FIG. 3 depicts a top perspective of an attachment apparatus to be fixably attached to a golf cart.

### DETAILED DESCRIPTION

The present invention apparatus and methods for removably but securely attaching a cooler to a golf cart.

In the following sections, detailed descriptions of examples and methods of the invention will be given. The description of both preferred and alternative examples, though thorough, are exemplary only. It should be understood that, to those skilled in the art, variations, modifications, and alternations may be apparent. The examples given do not limit the broadness of the aspects of the underlying invention, as defined by the claims.

The present disclosure uses the attachment of a drink cooler to a golf cart as an animating example. However, attaching drink coolers to other movable surfaces is within the scope of this disclosure. For example, the apparatus and methods described herein may be readily adaptable to all-terrain vehicles, sailboats, kayaks, cars, trucks, snowmobiles, or other types of recreational vehicles that navigate rough or dynamic terrain.

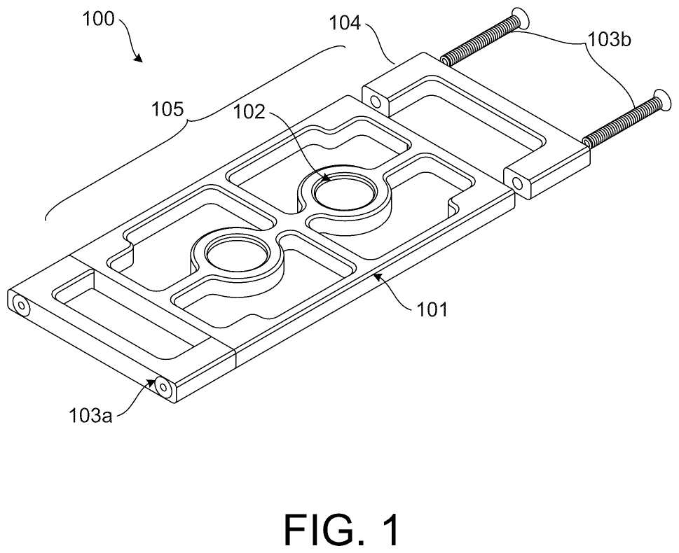

Referring now to FIG. 1, a plan view of cooler receiver plate 100 is shown. Cooler receiver plate 100 may comprise bracket frame 101, attachment receivers 102, countersunk fasteners 103a-103b, retainer strap receivers 104, and bracket body 105. In exemplary embodiments, bracket frame 101 may be made of a metallic alloy, to allow it to endure rough terrain traversed by golf carts. Bracket frame 101 may be precision-machined from industrial grade aluminum (e.g., 6061-T6 aluminum alloy) selected for, without limitation, strength-to-weight ratio, corrosion resistance, durability, and machinability. However, other suitable materials may include high-strength polymers such as fiber-reinforced nylon, injection-molded ABS plastic, or stainless steel alloys. In exemplary embodiments, the cooler receiver plate is made of a primarily non-magnetic material. However, bracket frame 101 may be made of any material of sufficient tensile strength to support at least part of the weight of a cooler. As shown in FIG. 1, bracket body 105 may contain one or more cutouts from the material of bracket frame 101. In exemplary embodiments, the configuration of these cutouts may be designed to fit (to an appropriate degree of snugness) with a topology of a surface of a cooler to assist cooler receiver plate 100 in locking into the cooler.

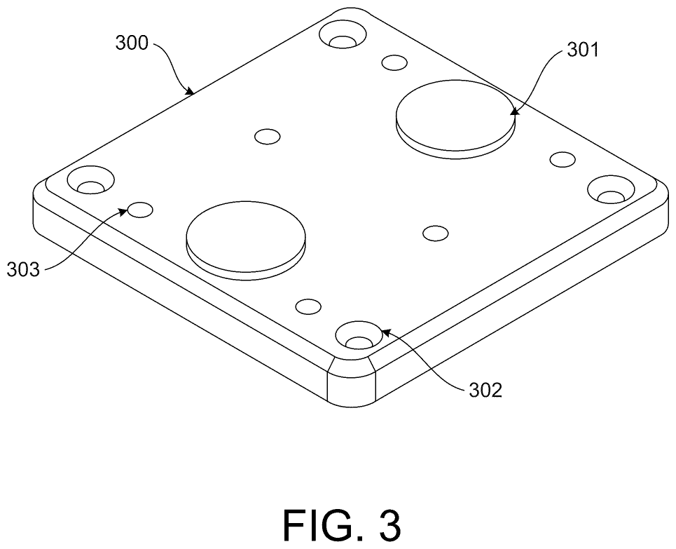

Attachment receivers 102 may be designed to receive an attachment mechanism for removably affixing a cooler to a surface, where the surface has an appropriate counter-attachment mechanism. For example, in exemplary embodiments, attachment receivers 102 may be recessed magnets to create a mechanical interlock with the base plate shown in FIG. 3. In exemplary embodiments, these magnets may be neodymium or ceramic magnets. In some embodiments, these may be secured to cooler receiver plate 100 with adhesive or fasteners, or they may be captured by a mold used to create cooler receiver plate 100. In other embodiments, attachment receivers 102 may be hook-and-loop fasteners, a surface configured to receive a suction device, a suction device, a nut, a hole, or any other suitable receiving mechanism. In most embodiments, the nature of this receiving mechanism may be determined by the mechanism chosen for the attachment apparatus, as shown in FIG. 3.

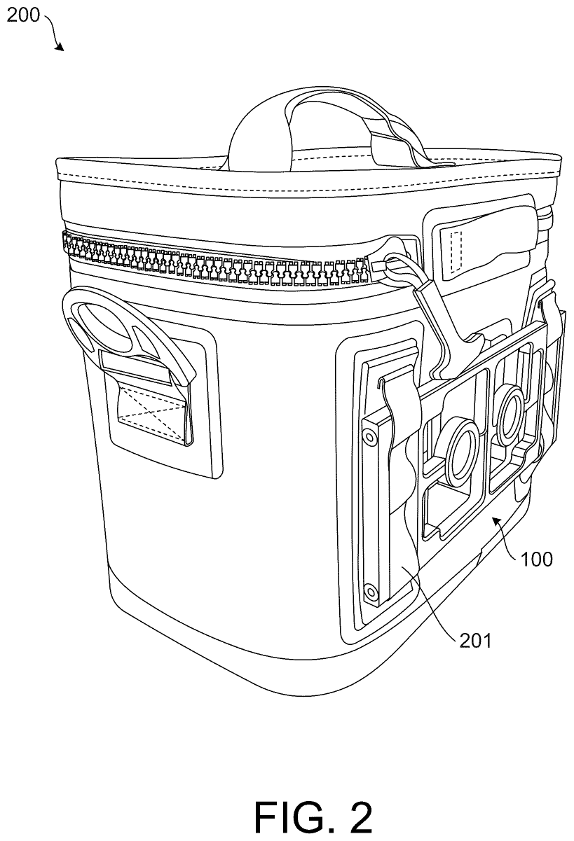

Optionally, cooler receiver plate 100 may further include retainer strap receivers 104. Retainer strap receivers 104 may provide grooves through which retainer straps located on a cooler may pass. For example, referring briefly to FIG. 2, retainer straps 201 pass through retainer strap receivers 104 to further secure cooler receiver plate 100 to cooler 200. In some embodiments, retainer strap receivers 104 comprise a unitary device having one or more solid pieces running parallel to the bounding frame of cooler receiver plate 100, and may attach to a main body 105 of cooler receiver plate 100. This attachment may be effected by welding, or it may be a fixable attachment, such as by a hook-and-loop fastener, a snap, or a screw passing through retainer strap receivers 104 and into a receiving portion of cooler bracket body 105. In exemplary embodiments, as shown in FIG. 1, countersunk fasteners 103a-103b may bind retainer strap receivers 104 to main body 105 to reduce the likelihood of snagging. Retainer strap receivers 104 may be machined or molded integrally or may be separately fabricated components attached via countersunk fasteners 103a-103b.

Bracket body 105 may include geometric cutouts or surface profiling explicitly engineered to engage surfaces or designated indentations on cooler 200, facilitating alignment and mechanical stability. These cutouts may be precision-machined or molded to tolerances of +/−0.1 mm to ensure snug and reliable interfacing.

Referring now to FIG. 2, cooler 200 is shown having cooler receiver plate 100 attached thereto. As discussed above, retainer strap receivers 104 on cooler receiver plate 100 receive retainer straps 201 affixed to cooler 200, to further secure cooler receiver plate 100 to cooler 200. Another mechanism provided to affix cooler receiver plate 100 to cooler 200 is the geometry of bracket frame 101. This geometry allows cooler receiver plate 100 to snap into plate on a side of cooler 200 to provide further stability to cooler receiver plate 100. In some embodiments, retainer straps 201 may also include straps, fasteners, hook-and-loop fasteners, or other affixing means. The affixing referred to herein may be temporary (as in the case in which cooler receiver plate 100 removably interlocks, via its geometry, into cooler 200, aided by retainer straps 201) or may be permanent (e.g., via welding, use of a heat-bonding agent, or other means).

Cooler 200 may represent any commercially available or custom cooler, typically formed from durable polymers (such as roto-molded polyethylene) or insulated composite materials. Cooler 200 includes retainer straps 201 designed to pass securely through retainer strap receivers 104. In exemplary embodiments, retainer straps 201 may be constructed from high-strength nylon webbing, polypropylene straps, or similar resilient material with resistance to environmental exposure, stretching, and fatigue.

In some embodiments, retainer straps 201 feature adjustable fastening mechanisms such as cam-buckle fasteners, quick-release buckles, hook-and-loop closures (Velcro®), or ratcheting tension devices, which allow users to adjust and secure the cooler 200 tightly and reliably against the cooler receiver plate 100. This adjustability ensures that the cooler 200 remains securely mounted even under varying load conditions or when traversing rough terrain.

Bracket frame 101 and bracket body 105 further enhance this secure connection through geometric interlocking with complementary shaped regions or recesses formed in the external structure of cooler 200. Specifically, bracket body 105 may incorporate precisely dimensioned geometric cutouts, indentations, or raised features that match corresponding surfaces on cooler 200. Such complementary geometric interfaces allow cooler receiver plate 100 to “snap” or frictionally engage with cooler 200, offering additional positional stability beyond that provided by retainer straps 201 alone.

Optionally, in alternative embodiments, cooler 200 and cooler receiver plate 100 may incorporate auxiliary securing mechanisms such as additional magnets embedded directly within corresponding regions of cooler 200. These magnets would interface with complementary magnets or metal inserts within bracket frame 101, providing further magnetic coupling to supplement the mechanical retention achieved by straps and geometry.

Additionally, cooler 200 may be optionally provided with integrated reinforcement points, such as embedded metallic inserts, anchor points, or reinforced polymer sections that interface specifically with retainer strap receivers 104 and attachment receivers 102 on cooler receiver plate 100. These reinforcement points enhance durability and stability under repeated stress from dynamic movements or frequent installation and removal cycles.

In exemplary embodiments, cooler receiver plate 100 may remain semi-permanently or permanently affixed to cooler 200, enabling rapid and reliable attachment and detachment from the attachment apparatus 300 (FIG. 3) mounted on a golf cart or other vehicle. Alternatively, cooler receiver plate 100 may be designed for easy removal from cooler 200 when desired, such as via quick-release straps or snap-fit mechanisms, thereby facilitating cleaning, maintenance, or storage.

Referring now to FIG. 3, attachment apparatus 300 is shown. In exemplary embodiments, attachment apparatus 300 is attached to a golf cart and adapted to receive cooler receiver plate 100. Attachment apparatus 300 includes attachment mechanism 301, for connecting the golf cart to cooler receiver plate 100. In the embodiment shown in FIG. 3, attachment mechanism 301 comprises magnets protruding from the surface of attachment apparatus 300, to create a mechanical interlock with cooler receiver plate 100. Attachment mechanism 301 may be attached to attachment apparatus 300 by adhesive or fasteners, or may be unitarily created as part of attachment apparatus 300 during the creation thereof. In other embodiments, attachment mechanism 301 may comprise a fastener, a hook-and-loop fastener, a screw, or another means of connecting to attachment receivers 102, as shown in FIG. 1. Attachment mechanism 301 may comprise protruding neodymium magnets that correspondingly mate with attachment receivers 102. The magnets may be press-fit, bonded using industrial epoxy adhesive (e.g., structural acrylic adhesive rated for vibration resistance), or integrally encapsulated during an injection molding process.

Attachment apparatus 300 may be fixably, removably, or permanently attached to a golf cart. The embodiment shown in FIG. 3 depicts two complementary (and not necessarily mutually exclusive or mutually required) methods of effecting this attachment. First, countersunk holes 302 allow topside mounting with application-specific fasteners (e.g., a wood screw, sheet metal screw, screw & nut, etc.). Tapped holes 303 permit multiple mounting options from a back side. Secondary L-brackets, U-bolts, straps, or other attachment means by also complement (or be a substitute for) the foregoing attachment means. The particular mounting method may depend on the topology of the golf cart, the anticipated usage/terrain for the golf cart, or other considerations.

In some embodiments, a golf cart may be manufactured having attachment apparatus 300. In some embodiments, the golf cart may have one or more components of attachment apparatus 300, but may be missing others; for example, the golf cart may be lacking attachment mechanism 301. In this case, a suitable attachment mechanism 301 may be attached to the golf cart; for example, a sufficient adhesive may be applied to one or more magnets, which may be placed in an orientation to allow such magnets to be received by attachment receivers 102.

Attachment apparatus 300 may also incorporate vibration-damping materials (e.g., neoprene pads, silicone layers, or elastomeric isolators) integrated beneath or around the magnet interfaces to reduce the transmission of vibration, providing additional mechanical advantage and enhancing durability.

As discussed above, attachment apparatus 300 may be attached to (or formed integrally in) recreational vehicles other than golf carts. For example, attachment apparatus 300 may be attached to a snowmobile or all-terrain vehicle without interfering with the operation thereof. Attachment apparatus 300 and cooler receiver plate 100 may include modifications for such different contexts. For example, when used with an all-terrain vehicle (ATV) or utility task vehicle (UTV), attachment apparatus 300 may be ruggedized for secure and vibration-resistant transport during off-road conditions. Modifications may include reinforced brackets or shock-absorbing mounts to handle greater dynamic force. Modifications may also include corrosion-resistant materials such as marine-grade aluminum, stainless steel alloys, or polymers resistant to UV and saltwater degradation for marine applications.

In exemplary embodiments, attachment apparatus 300 and/or cooler receiver plate 100 may be machined from industrial aluminum, which is not magnetic under most circumstances. This allows the attachment of the two pieces to come primarily from the interaction between the two spot magnets. Accordingly, other non-magnetic (or less magnetic) materials may be used, such as injection-molded or printed plastics. The magnets may be neodymium magnets or other magnets with similar pull ratings. While the magnets shown herein are round, different magnet shapes may be desirable in other applications.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. Nevertheless, it will be understood that various modifications may be made without departing from the spirit and scope of the claimed disclosure.

What is claimed is:

1. A cooler mounting apparatus comprising:
a cooler receiver plate having a bracket frame configured for removably coupling with a cooler;
a plurality of attachment receivers disposed on the bracket frame, wherein the attachment receivers comprise at least one magnetically interactive component; and
an attachment apparatus configured to be fixably attached to a movable surface, wherein the attachment apparatus comprises complementary interactive components adapted for removable engagement with the cooler receiver plate.

2. The cooler mounting apparatus of claim 1, wherein the complementary interactive components include a magnet.

3. The cooler mounting apparatus of claim 2, wherein the movable surface comprises a surface of a golf cart.

4. The cooler mounting apparatus of claim 3, wherein the bracket frame comprises a metallic alloy.

5. The cooler mounting apparatus of claim 3, wherein the bracket frame comprises a non-metallic material.

6. The cooler mounting apparatus of claim 3, wherein the attachment receivers comprises magnets recessed within the bracket frame.

7. The cooler mounting apparatus of claim 1, further comprising retainer strap receivers disposed on the bracket frame and configured to receive retainer straps for securing the cooler to the cooler receiver plate.

8. The cooler mounting apparatus of claim 7, wherein the retainer strap receivers are integrally formed with the bracket frame.

9. The cooler mounting apparatus of claim 7, further comprising adjustable retainer strap receivers configured to pass through the retainer strap receivers.

10. The cooler mounting apparatus of claim 9, wherein the retainer straps include an adjustable fastening mechanism.

11. The cooler mounting apparatus of claim 1, wherein the cooler receiver plate further comprises geometric cutouts or raised surface features configured to mechanically engage complementary structures on a surface of the cooler.

12. The cooler mounting apparatus of claim 1, wherein the attachment apparatus comprises a plurality of magnets disposed in a configuration complementary to the attachment receivers, forming a magnetic interlock when engaged.

13. The cooler mounting apparatus of claim 1, wherein the attachment apparatus further comprises at least one vibration-damping element disposed adjacent to the complementary interactive components.

14. The cooler mounting apparatus of claim 13, wherein the movable surface comprises a surface on an all-terrain vehicle.

15. The cooler mounting apparatus of claim 1, wherein the attachment apparatus further comprises multiple attachment points.

16. The cooler mounting apparatus of claim 1, wherein the attachment apparatus is formed integrally with the movable surface.

17. The cooler mounting apparatus of claim 1, wherein the attachment apparatus and the cooler receiver place each comprise a corrosion-resistant surface treatment.

18. The cooler mounting apparatus of claim 1, wherein the cooler comprises embedded magnets arranged complementary to magnets or attachment receivers in the cooler receiver plate.
